(19) United States
(12) Patent Application Publication
(10) Pub. No.: US 2014/0327845 A1
(43) Pub. Date: Nov. 6, 2014

(54) TOUCH PANEL

(71) Applicant: SHARP KABUSHIKI KAISHA, Osaka-shi, Osaka (JP)

(72) Inventors: Yuhji Yashiro, Osaka-shi (JP); Yasuhiro Sugita, Osaka-shi (JP); Kazutoshi Kida, Osaka-shi (JP); Shinji Yamagishi, Osaka-shi (JP)

(21) Appl. No.: 14/360,983

(22) PCT Filed: Sep. 19, 2012
(86) PCT No.: PCT/JP2012/073953

§ 371 Date: May 28, 2014

(30) Foreign Application Priority Data
Dec. 2, 2011 (JP) 2011-265229

(51) Int. Cl. G06F 3/041

(52) U.S. Cl. CPC G06F 3/041
USPC 349/12

(57) ABSTRACT

A touch panel includes: a group (10) of a plurality of driving electrodes provided in parallel to one another; and a group (20) of a plurality of sensing electrodes provided in parallel to one another, wherein: each one of the plurality of driving electrodes is provided with sub-electrodes (101(n) through 104(n)) extending in a direction orthogonal to a direction in which the plurality of driving electrodes extend; and the sub-electrodes have a decreasing electrode area gradient from a main body portion (main electrode (100(n))) of the each driving electrode to a far side with respect to the main body portion.

### TECHNICAL FIELD

The present invention relates to a touch panel, and more specifically to a capacitive touch panel.

### BACKGROUND ART

Currently, a touch panel is widely used for mobile phones etc. The touch panel allows a user to input a touched position (contact position) by touching the touched position with a fingertip, a pen tip, or the like while viewing an image displayed on a display screen that is made of a liquid crystal panel etc.

Conventionally, various types of touch panels have been proposed as such a touch panel. Among the various types of touch panels, capacitive touch panels have simple operability with use of a finger when being used. Therefore, capacitive touch panels have been widely used.

FIG. 9 is a view illustrating an example of a capacitive touch panel. (a) of FIG. 9 is a plan view of a touch panel in a case where the touch panel is viewed from above. (b) of FIG. 9 is a cross-sectional view taken along line A-A′ in (a) of FIG. 9. (c) of FIG. 9 is a view illustrating a condition in a case where the touch panel is touched with a fingertip. In (a), (b), and (c) of FIG. 9, the reference sign 90 indicates a substrate made of a transparent insulator. On respective front and back surfaces of the substrate 90, a plurality of driving electrodes (also referred to as drive electrodes) 91 and a plurality of sensing electrodes (also referred to as sense electrodes) 92 are formed. The substrate 90 serves as an insulating layer between the driving electrodes 91 and the sensing electrodes 92.

As illustrated in (a) of FIG. 9, the plurality of driving electrodes 91 and the plurality of sensing electrodes 92 are formed so as to orthogonally intersect with each other. Further, a cover glass 93 is provided so as to cover the sensing electrodes 92. This cover glass 93 is made of a transparent insulator. Note that in (a) of FIG. 9, the substrate 90 intervening between the driving electrodes 91 and the sensing electrodes 92 is shown by broken lines, but illustration of the cover glass 93 is omitted for simplification of the drawing.

Because the driving electrodes 91 and the sensing electrodes 92 are opposed to each other via the substrate 90 that is an insulator, a capacitance is formed between the driving electrodes 91 and the sensing electrodes 92. Accordingly, when voltage is applied between the driving electrodes 91 and the sensing electrodes 92, lines of resulting electric force is as illustrated in (b) of FIG. 9. The lines of electric force includes (i) a parallel-plate component 95 that is formed in areas where the driving electrodes 91 and the sensing electrodes 92 face each other and (ii) a fringe component 94 that is formed in fringe areas of the areas where the driving electrodes 91 and the sensing electrodes 92 face each other.

When such a touch panel is touched with a fingertip or the like from above the cover glass 93 as illustrated in (c) of FIG. 9, earth connection via the fingertip is formed. As a result, a capacitance is formed between the fingertip and a driving electrode 91. Consequently, the capacitance between the driving electrode 91 and a sensing electrode 92 changes. By detecting where this change in capacitance has occurred, a point touched with the fingertip or the like is detected.

In the touch panel as illustrated in FIG. 9, the substrate is made of an insulator such as PET, typically. The substrate had a thickness of a few hundred micrometers, for example, approximately 200 μm. In this case, among the lines of electric force relevant to the capacitance that is formed between the driving electrodes and the sensing electrodes, the fringe capacitance component 94 contributing to sensitivity of the touch panel also comes from positions that were far apart from the sensing electrodes 92 (approximately 1.8 mm apart from one side of a sensing electrode 92), as illustrated in (b) of FIG. 9, and such a fringe capacitance component 94 was relatively weak.

In the touch panel as illustrated in FIG. 9, the sensing electrodes 92 were required to have a certain level of distance (approximately 5 mm) between two adjacent sensing electrodes 92 so that deterioration in sensitivity is prevented. Furthermore, there was a limitation to improvement in sensitivity by means of providing a wide space between two adjacent sensing electrodes 92. In addition, because it is difficult to narrow the space between two adjacent sensing electrodes, it was difficult to improve detection accuracy.

FIG. 10 illustrates a relation between a detected position and a detected voltage that is obtained by use of a sensing electrode at the time when an n-th driving electrode 91(n) is driven, in a touch panel including a group of a plurality of driving electrodes 91 and a group of a plurality of sensing electrodes 92. (a) of FIG. 10 schematically illustrates the touch panel including three driving electrodes 91(n−1), 91(n), and 91(n+1) among the plurality of driving electrodes 91 and three sensing electrodes 92(m−1), 92(m), and 92(m+1) among the plurality of sensing electrodes 92. (b) of FIG. 10 illustrates a relation between a detected voltage and each of pen tip positions 1 and 2 of a pen tip placed on the touch panel.

When a position in the vicinity of the sensing electrode 92(m) on the driving electrode 91(n) is touched with a pen tip 96, a detection signal (voltage) occurs at the sensing electrode 92(m). (b) of FIG. 10 schematically illustrates the detection signal (voltage) in such a case. In this case, as illustrated in (b) of FIG. 10, there is no significant difference between respective detection signals (voltages) for an upper position 1 and a lower position 2 in the illustration of the driving electrode 91(n). Typically, the driving electrodes each have a width of approximately 5 mm. Even with the use of the pen tip 96 that is thinner than the width of the driving electrode, a position of the pen tip 96 on the driving electrode 91(n) cannot be determined. In other words, it is difficult to locate a more detailed position of the pen tip 96 in a Y-axis direction.

If the driving electrodes each are divided into smaller pieces, detection of a position in the Y-axis direction can have a higher accuracy. However, in this case, a value of a detection output voltage becomes lower unless an operation frequency is lowered. In such a case, the operation frequency has to be lowered in practice. In other words, when the driving electrodes each are divided into a pieces, the number of the driving electrodes increases by a times.

Accordingly, time taken for full scan also increases by a times. This consequently lowers the operation frequency. On the other hand, when the operation frequency is to be kept constant, the number of times of burst waveform application (the number of times of integration) to each driving electrode needs to be decreased to 1/α. This weakens a signal (S/n).

Note that FIG. 11 illustrates one exemplary detection circuit of the capacitive touch panel as illustrated in FIG. 9. The detection circuit itself is a known art because various circuits have been proposed as such a detection circuit.

Accordingly, a detailed explanation of the detection circuit is omitted here.

Patent Literature 1 discloses a technique for simultaneously driving a plurality of driving electrodes for the purpose of enhancing an SNR (Signal Noise Ratio) of a capacitive touch panel.

FIG. 12 is a view schematically illustrating a touch panel disclosed in Patent Literature 1. In (a) of FIG. 12, E1_{—}1 through E1_n indicates n driving electrodes aligned in a scanning direction. The touch panel is further provided with k sensing electrodes E2_{—}1 through E2_k so that these sensing electrodes orthogonally intersect with the driving electrodes. The sensing electrodes are connected to a voltage detector DET. In (a) of FIG. 12, the reference sign 11 indicates a detection drive scanning section for driving the driving electrodes.

When the touch panel is in operation, the detection drive scanning section 11 in (a) of FIG. 12 selects and drives an alternate-current driving electrode unit EU including m (2≦m<n) successive driving electrodes out of the n driving electrodes. The detection drive scanning section 11 in (a) of FIG. 12 carries out a shift operation which shifts the alternating-current driving electrode unit EU to be selected in the scanning direction. This shift operation is repeated in a manner such that at least one driving electrode is selected commonly both before and after each shift operation. In (a) of FIG. 12, the voltage detector DET compares a potential of each corresponding sensing electrode with a predetermined threshold Vt every time the detection drive scanning section 11 carries out the shift operation.

(b), (c) and (d) of FIG. 12 each illustrate a specific aspect of driving. In other words, as illustrated in (b), (c) and (d) of FIG. 12, 7 (m=7) driving electrodes as one set is selected as the driving electrode unit EU, and scanned at T1, T2, T3 . . . while shifted by one driving electrode each time.

This is intended to simultaneously improve detection accuracy and an SNR.

### CITATION LIST

### Patent Literature

### Patent Literature 1

Japanese Patent Application Publication
Tokukai, No. 2010-092275 (Publication Date: Apr. 22, 2010)

### SUMMARY OF INVENTION

### Technical Problem

The invention disclosed in Patent Literature 1 can be expected to improve both detection accuracy and an SNR, as compared to those of conventional techniques. However, time taken for full scan of driving electrodes becomes m times longer than that in conventional techniques. This consequently lowers the operation frequency to 1/m. Meanwhile, in a case where the operation frequency is fixed, the number of times of integration is decreased to 1/m and this consequently weakens a signal (output signal).

The present invention is attained in view of the above problems of the conventional techniques. An object of the present invention is to provide a touch panel that is capable of accomplishing all of (i) no lowering of an operation frequency, (ii) an ensured number of times of integration and a consequent low signal stroke, and (iii) a high detection accuracy.

### Solution to Problem

In order to solve the above problems, a touch panel according to one aspect of the invention of the present application includes: a plurality of driving electrodes provided in parallel to one another; and a plurality of sensing electrodes insulated from the plurality of driving electrodes via an insulator and provided in parallel to one another, the plurality of driving electrodes and the plurality of sensing electrodes being provided in a matrix form so as to orthogonally intersect with each other, the plurality of driving electrodes extending in an X-axis direction of the touch panel, the plurality of sensing electrodes extending in an Y-axis direction of the touch panel, the plurality of driving electrodes each being made of (i) a main electrode extending so as to orthogonally intersect with the plurality of sensing electrodes and (ii) at least a pair of sub-electrodes provided in a region between two adjacent sensing electrodes so as to extend in an orthogonal direction with respect to the main electrode and respectively in opposite directions relative to the main electrode, the pair of sub-electrodes each having a decreasing electrode area gradient from a main electrode side to a far side with respect to the main electrode, and the main electrode and the pair of sub-electrodes of one of the plurality of driving electrodes being electrically connected to each other.

This aspect of the present invention makes it possible to provide a high-performance touch panel that can detect, with a high accuracy, a touched position between driving electrodes without increasing the number of driving electrodes and therefore without lowering of an operation frequency. In other words, because a signal strength varies depending on a driving electrode area, detection accuracy of a touched position is improved by reading the signal strength that varies (that is modulated) depending on the driving electrode area. Further, the number of driving electrodes is not increased. This prevents (i) the operation frequency from disadvantageously lowering or (ii) a signal from being disadvantageously weakened due to decrease in the number of times of integration.

### Advantageous Effects of Invention

As described above, the invention of the present application can provide a touch panel capable of accomplishing all of (i) no lowering of an operation frequency, (ii) an ensured number of times of integration and a consequent low signal stroke, and (iii) a high detection accuracy.

### BRIEF DESCRIPTION OF DRAWINGS

FIG. 1 is a view illustrating an outline and an operation principle of a touch panel according to Embodiment 1 of the present invention.

FIG. 2 is a view illustrating a detailed configuration of the touch panel according to Embodiment 1 of the present invention.

FIG. 3 is a view illustrating a modified example of the touch panel according to Embodiment 1 of the present invention.

FIG. 4 is a view illustrating a configuration of a touch panel according to Embodiment 2 of the present invention.

FIG. 5 is a view illustrating in details the touch panel according to Embodiment 2 of the present invention.

FIG. 6 is a view schematically illustrating an outline of a touch panel according to Embodiment 3 of the present invention.

FIG. 7 is a view illustrating details and an operation principle of the touch panel according to Embodiment 3 of the present invention.

FIG. 8 is a view illustrating an operation state of the touch panel according to Embodiment 3 of the present invention.

FIG. 9 is a view illustrating an operation principle of a capacitive touch panel.

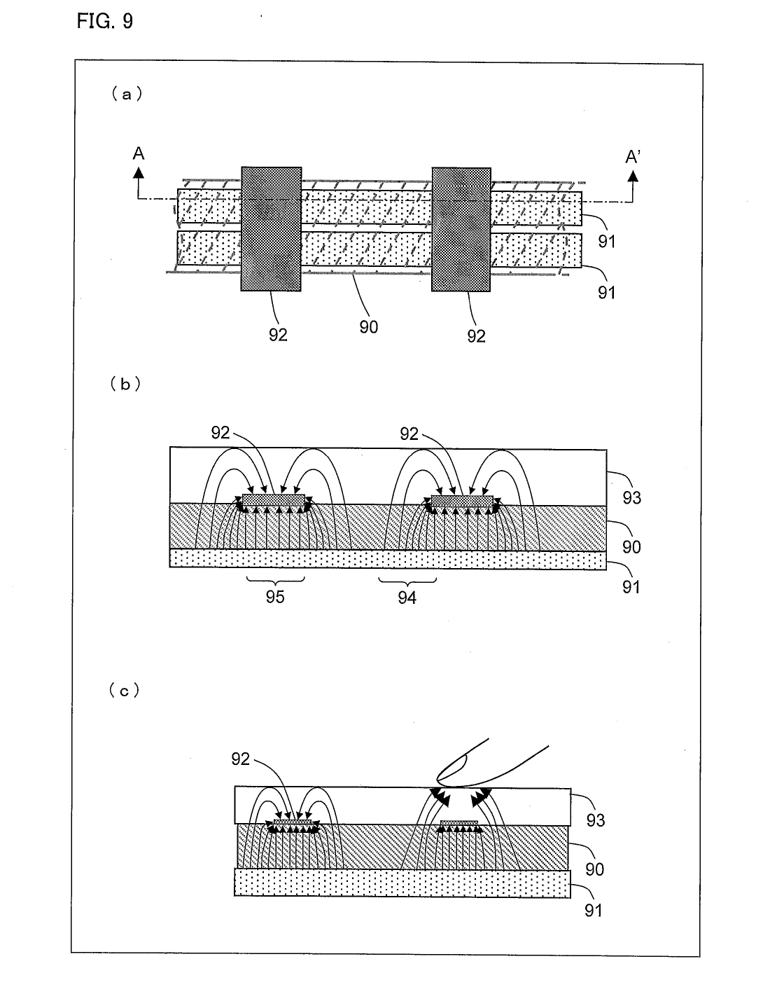

FIG. 10 is a view illustrating detection accuracy of a conventional touch panel.

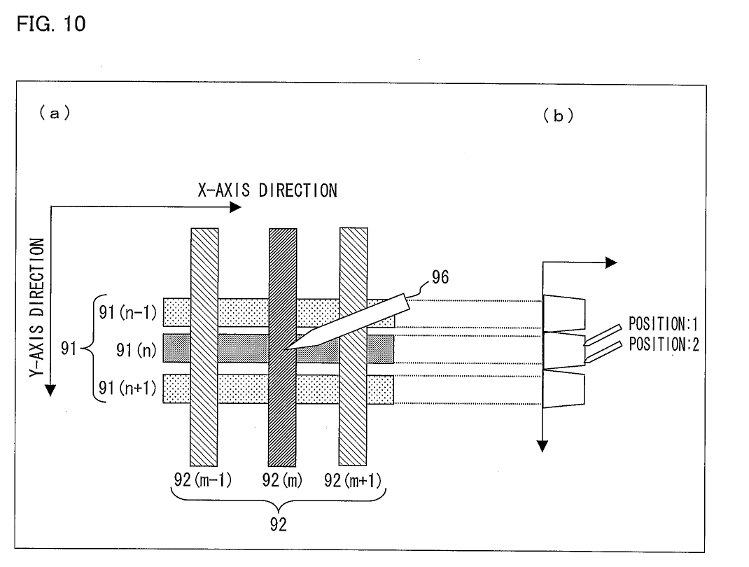

FIG. 11 is a view illustrating one example of a detection circuit of a capacitive touch panel.

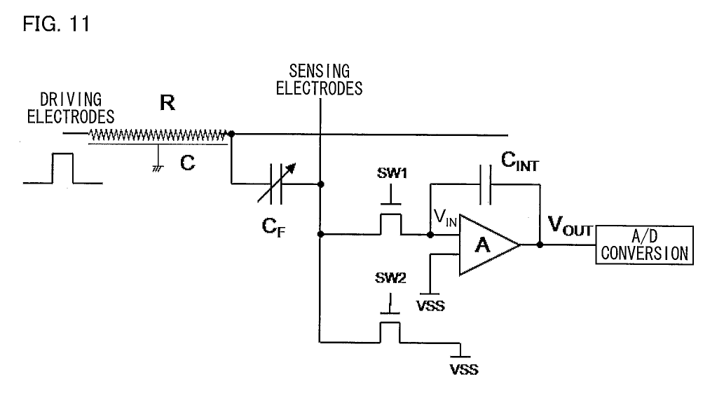

FIG. 12 is a view illustrating another example of a conventional touch panel.

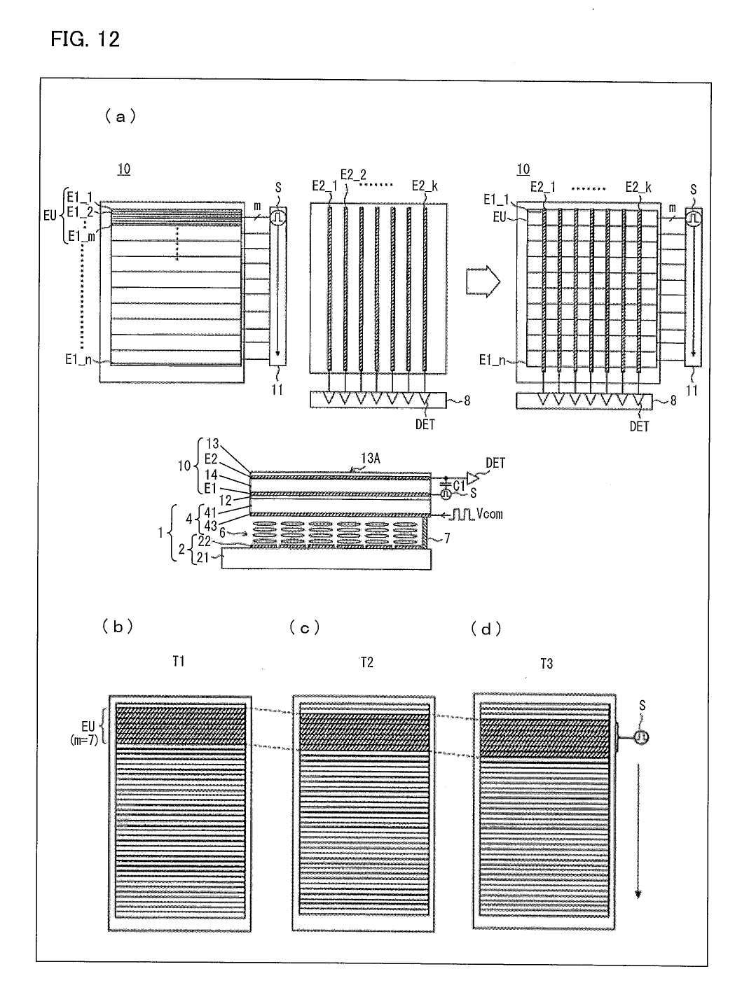

### DESCRIPTION OF EMBODIMENTS

The following discusses in detail the present invention with reference to drawings. Note that though various limitations that are preferred for carrying out the present invention are given in the following discussion, the technical scope of the present invention is limited by no means to the following descriptions of Embodiments and drawings. In the following discussion, identical members or the like are given an identical reference sign throughout the discussion and accordingly, repeated description of one member or the like is omitted.

### Embodiment 1

The following discusses a first embodiment

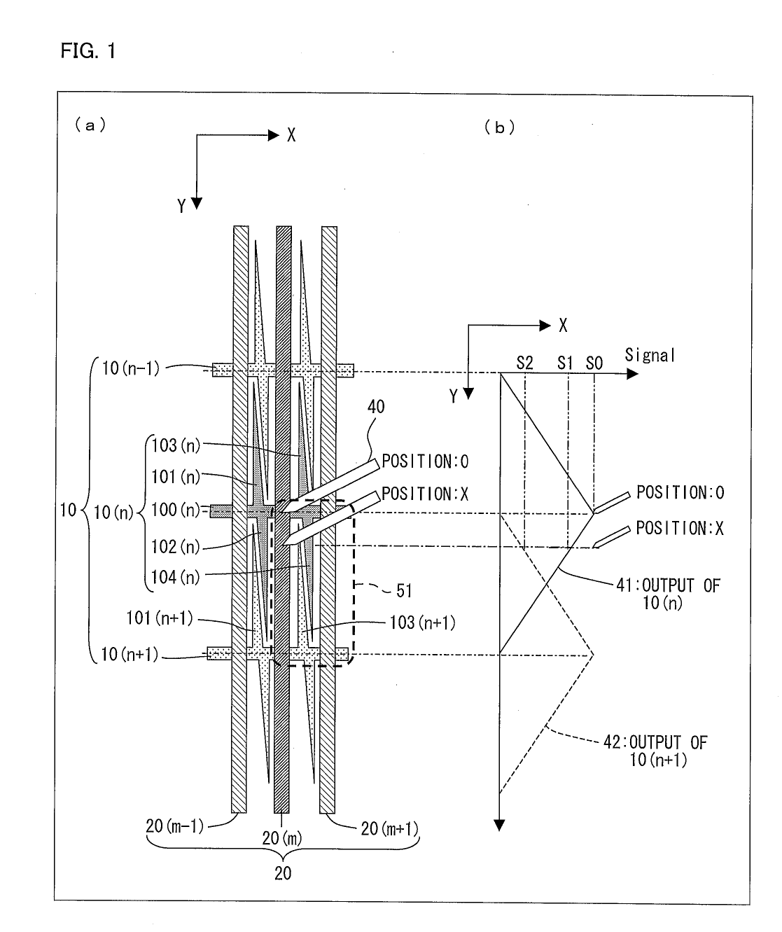

(Embodiment 1) of the present invention, with reference to FIGS. 1 through 3.

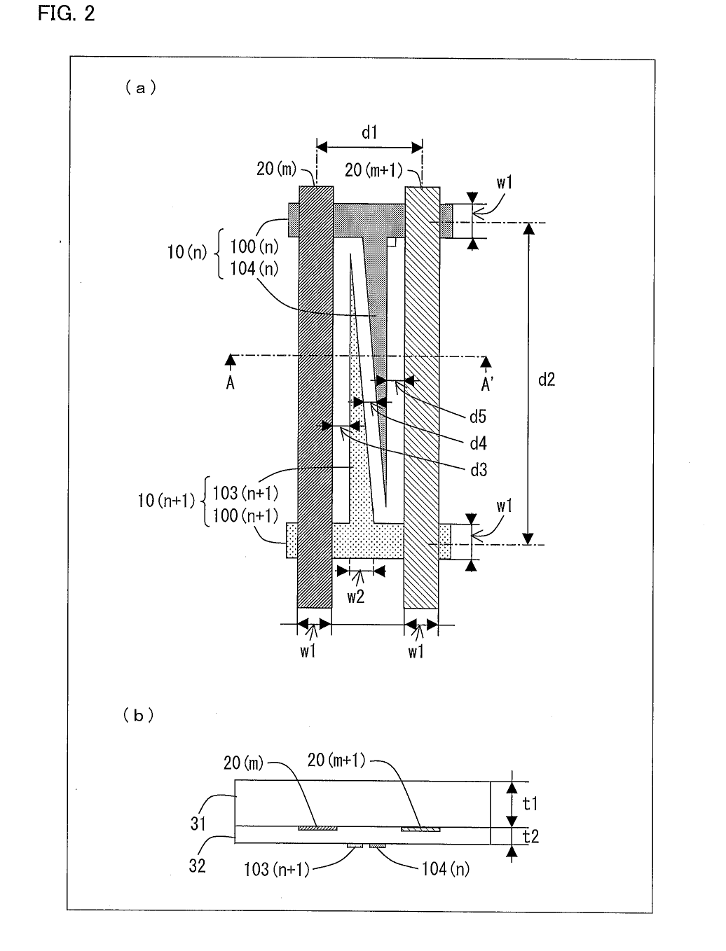

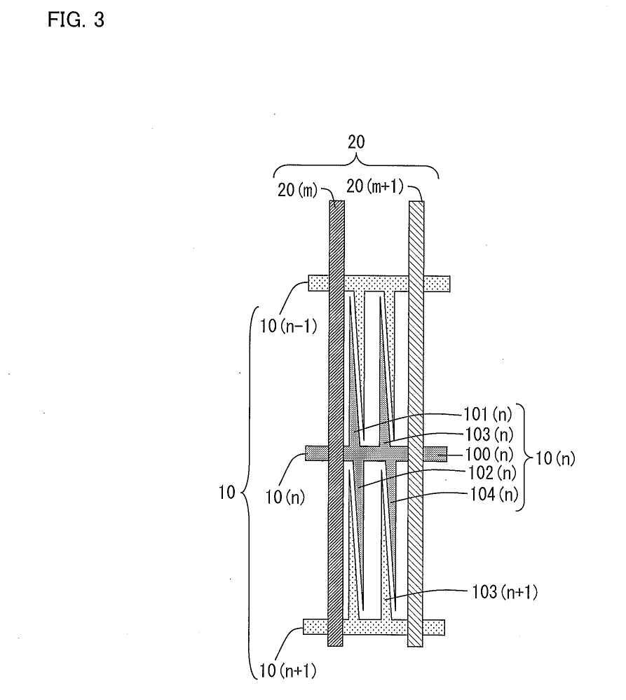

The following first describes a principle operation of the present invention with reference to (a) and (b) of FIG. 1, and then, describes a detailed configuration of a touch panel according to Embodiment 1 with reference to FIG. 2. Further, with reference to FIG. 3, a modified example of Embodiment 1 is discussed.

(a) of FIG. 1 is a view schematically illustrating an electrode configuration of the touch panel according to Embodiment 1 of the present invention. (b) of FIG. 1 is a view illustrating an operation of the touch panel according to Embodiment 1 of the present invention.

In (a) of FIG. 1, the reference sign 10 indicates a driving electrode group that is made of a plurality of driving electrodes, and the reference 20 indicates a sensing electrode group that is made of a plurality of sensing electrodes. Both the driving electrode group 10 and the sensing electrode group 20 are provided all over the touch panel. While the driving electrode group 10 extends in an X-axis direction, the sensing electrode group 20 extends in a Y-axis direction. Further, the driving electrodes and the sensing electrodes are provided in a matrix form so as to orthogonally intersect with each other. Note that though the driving electrodes may also be called drive electrodes, drive lines, or the like, the term “driving electrodes” is used herein. Similarly, though the sensing electrodes may also be called sense electrodes, sense lines, or the like, the term “sensing electrodes” is used herein.

In (a) of FIG. 1, as the driving electrode group 10, three driving electrodes 10(n−1), 10(n), and 10(n+1) provided in parallel to one another are illustrated, while as the sensing electrode group 20, three sensing electrodes 20(m−1), 20(m), and 20(m+1) provided in parallel to one another are illustrated. The plurality of driving electrodes have an identical configuration while the plurality of sensing electrodes also have an identical configuration. Accordingly, when a configuration of the driving electrodes is to be described, the driving electrode 10(n) is used for such a description. Meanwhile, when a configuration of the sensing electrodes is to be described, the sensing electrode 20(m) is used for such a description.

The driving electrode 10(n) is made of a main electrode 100(n) extending in a lateral direction (X-axis direction) in (a) of FIG. 1 and triangular sub-electrodes 101(n), 102(n), 103(n), and 104(n) protruding in a vertical direction (Y-axis direction) from the main electrode 100(n) in (a) of FIG. 1. It is clear that these sub-electrodes 101(n) etc. are configured to have a triangle shape whose one side is a side of the main electrode 100(n) etc. and whose vertex is on a side where another main electrode of another adjacent driving electrode is provided, for example, on a side where a main electrode 100(n+1) of another driving electrode 10(n+1) is provided (see also (a) of FIG. 2).

Note that in the present specification, the description such that the driving electrodes are “provided in parallel to one another” means that “the plurality of driving electrodes 10(n), 10(n+1) . . . ” each including “a main electrode 100(n) and sub-electrodes 101(n), 102(n) . . . ” are configured so that extended lines of the plurality of driving electrodes 10(n), 10(n+1) . . . never intersect with each other.

In Embodiment 1 of the present invention as illustrated in FIG. 1, a pair of sub-electrodes 101(n) and 102(n) are provided between a pair of adjacent sensing electrodes, for example, between the sensing electrodes 20(m−1) and 20(m). The sub-electrodes 101(n) and 102(n) each extend in a triangular form in the Y direction (a direction parallel to the extending direction of the sensing electrode group 20) from the main electrode 100(n) of the driving electrode 10(n). In other words, the driving electrode 10(n) is made of (i) the main electrode 100(n) that orthogonally intersects with the sensing electrode 20(m) and that extends in the X-axis direction of the touch panel and (ii) at least the pair of sub-electrodes 101(n) and 102(n) that are provided in a region between adjacent sensing electrodes (for example, a region between the sensing electrodes 20 (m−1) and 20(m)) and that extend in an orthogonal direction with respect to the main electrode 100(n) and respectively in opposite directions relative to the main electrode 100(n). This configuration forms a gradually decreasing electrode area gradient of each of the sub-electrodes 101(n) and 102(n) from the main electrode 100(n) of the driving electrode 10(n) to a far side with respect to the main electrode 100(n).

(b) of FIG. 1 illustrates a level of a detection signal (voltage) in a touch panel including the sub-electrodes 101(n) and 102(n) each having the gradually decreasing electrode area gradient as described above. The detection signal is a signal to be detected when a pen tip 40 touches the touch panel. Note that (b) of FIG. 1 is a graph that is simplified to illustrate an operation principle of the touch panel according to the present invention and therefore that does not show a precise characteristic of the touch panel. Further, not only the pen tip but also a fingertip or the like similarly allows detection of a touched position. According to the present invention, a touched position can be detected by an object having a smaller tip portion. Accordingly, in Embodiment 1, the detection is carried out by the pen tip 40.

In (b) of FIG. 1, a solid line 41 shows a level of a detection output (signal) for the driving electrode 10(n). In (b) of FIG. 1, the Y-axis direction represents a position where the pen tip 40 touches while the X-axis direction represents a level of a signal (detection output) to be detected. As described above, the sub-electrodes 101(n) and 102(n) of the driving electrode 10(n) are configured to have the gradually decreasing electrode area gradient from the main electrode 100(n) of the driving electrode 10(n) to a far side with respect to the main electrode 100(n). Accordingly, when the pen tip 40 is placed on a point on a portion of the main electrode 100(n), the detection output becomes the maximum output S0 because respective areas of the sub-electrode 101(n) and 102(n) are the maximum at the point. This detection output decreases as the pen tip 40 moves away from the main electrode 100(n). In other words, when the pen tip 40 is at a position X away from the main electrode 100(n), the detection output becomes an output S1 that is smaller than the maximum output S0.

By appropriately defining the above-described electrode area gradient, it is possible to design a characteristic of the detection output of the driving electrode 10(n) so that the detection output varies substantially linearly. If characteristic values of this detection output are measured in advance, the position X of the pen tip 40 can be accurately calculated. This makes it possible to accurately detect a position between the driving electrodes (n) and (n+1) without increasing the number of driving electrodes.

Note that a broken line 42 represents a detection output for the driving electrode 10(n+1). Accordingly, the detection output is hardly obtained when the pen tip 40 is at a position 0. Meanwhile, when the pen tip 40 is at the position X, a detection output S2 is obtained. Therefore, the position X of the pen tip 40 can be calculated from the two detection outputs for adjacent two driving electrodes (driving electrodes 10(n) and 10(n+1)). This makes it possible to more accurately detect a touch position.

FIG. 2 is a view illustrating a more detailed electrode configuration of the touch panel illustrated in FIG. 1. (a) of FIG. 2 is an enlarged view of only a portion 51 enclosed by the driving electrodes 10(n) and 10(n+1) and the sensing electrodes 20(m) and 20(m+1) in the electrode configuration of the touch panel as illustrated in (a) of FIG. 1. (b) of FIG. 2 is a cross-sectional view taken along line A-A′ of (a) of FIG. 2.

In FIG. 2, members identical to respective members illustrated in FIG. 1 are given identical numbers, respectively, and therefore, explanations thereof are omitted here. In (b) of FIG. 2, the reference sign 31 indicates a transparent substrate such as a glass substrate, typically. On this transparent substrate 31, the sensing electrodes 20(m) and 20(m+1) are formed. The sensing electrodes 20(m) and 20(m+1) are made of transparent metal such as ITO, IZO, or the like. On the transparent substrate 31, an insulator (insulating layer) 32 made of PET or the like is further formed. On this insulator 32, the driving electrodes 103(n+1) and 104(n) made of transparent metal are formed. In Embodiment 1, the transparent substrate 31 is configured to have a thickness t1 of approximately 500 μm and the insulator 32 made of PET or the like is configured to have a thickness t2 of approximately 2 μm. In other words, the sensing electrode 20(m) and the driving electrode 10(n) are insulated from each other via an insulator that is the insulator 32 made of PET or the like.

(a) of FIG. 2 illustrates a concrete exemplary design of the electrode configuration of the touch panel according to Embodiment 1 of the present invention. In this exemplary design, each of the driving electrodes 10(n), 10(n+1), etc. and the sensing electrodes 20(m), 20(m+1), etc. are configured to have an identical width w1 of approximately 500 μm. Further, a distance d1 between adjacent sensing electrodes (between a center of the sensing electrode 20(m) and a center of the sensing electrode 20(m+1)) is configured to be approximately 1300 μm, while a distance d2 between adjacent driving electrodes (between the driving electrode 10(n) and the driving electrode 10(n+1)) is configured to be approximately 5000 μm.

Further, the triangular sub-electrode 104(n) provided in the driving electrodes 10(n) is configured to have a right triangle shape that is protruding from the main electrode 100(n) so as to have a right angle with respect to the main electrode 100(n) on a sensing electrode 20(m+1) side. Meanwhile, the sub-electrode 103(n+1) provided in the driving electrode 10(n+1) is configured to have a right triangle shape that is protruding from the main electrode 100(n+1) so as to have a right angle with respect to the main electrode 100(n+1) on a sensing electrode 20(m) side. Furthermore, all of the sub-electrodes 104(n), 103(n+1), etc. are configured to have an identical shape and both of a distance d3 from the sensing electrode 20(m) to the sub-electrode 103(n+1) and a distance d5 from the sensing electrode 20(m+1) to the sub-electrode 103(n) are configured to be approximately 200 μm. In addition, a base portion of the right triangle is configured such that a base portion of the right triangle has a width w2 of approximately 250 μm, and a distance d4 between the sub-electrodes 104(n) and 103(n+1) is configured to be approximately 150 μm.

Note that configuring the sub-electrodes to have a right triangle shape makes it possible to form the sub-electrodes in a manner such that a space between the adjacent electrodes 20(m) and 20(m+1) provided in parallel to each other can be effectively utilized. In other words, this configuration makes it possible to have an efficient layout of the sub-electrodes relative to the space in a configuration where the driving electrodes and the sensing electrodes orthogonally intersect with each other. Moreover, the distance d3 between a driving electrode and a sensing electrode that are adjacent to each other is one factor that causes variation in signal strength (detection output) to be detected. Accordingly, it is preferable to keep the distance d3 (FIG. 2) between the driving electrode and the sensing electrode that are adjacent to each other constant and on this account, to configure the sub-electrodes in the form of a right triangle, for exclusion of factors, except the electrode area gradient, that may vary a level of a signal. Configuring the sub-electrodes in the form of a right triangle consequently makes it easy to design.

In general, depending on respective concrete numerical values of the above-described portions, a resulting output may significantly vary. Further, currently, it is difficult to accurately predict an outcome in relation to a portion where a numerical value is to be changed and how the numerical value is changed. However, it is confirmed that the numerical values provided above as examples lead to performance (an output of approximately 5 volts at the maximum as a detection output) that is sufficient for practical use.

Note that in Embodiment 1 of the subject application as illustrated in FIG. 1, the pair of sub-electrodes 101(n) and 102(n) are provided to the main electrode 100(n) of the driving electrode 10(n), between adjacent sensing electrodes, for example, between the sensing electrodes 20(m−1) and 20(m). However, the present invention is not limited to this configuration. The following discusses a modified example of Embodiment 1, with reference to FIG. 3.

FIG. 3 illustrates a modified example of Embodiment 1. As illustrated in FIG. 3, two or more pairs of sub-electrodes, for example, sub-electrodes 101(n), 102(n), 103(n), and 104(n) may be provided between the sensing electrodes 20(m) and 20(m+1). FIG. 3 illustrates two triangular sub-electrodes 101(n) and 103(n) extending upward from the main electrode 100(n) of the driving electrodes 10(n) and triangular sub-electrodes 102(n) and 104(n) extending downward from the main electrode 100(n) of the driving electrodes 10(n).

In the touch panel of Embodiment 1 described above, the sub-electrodes constituting a part of the driving electrodes each are configured to have a triangle shape and thereby, the driving electrodes each are given an electrode area gradient. This makes it possible to improve accuracy of detection of a touched position of the touch panel, without increasing the number of the driving electrodes.

### Embodiment 2

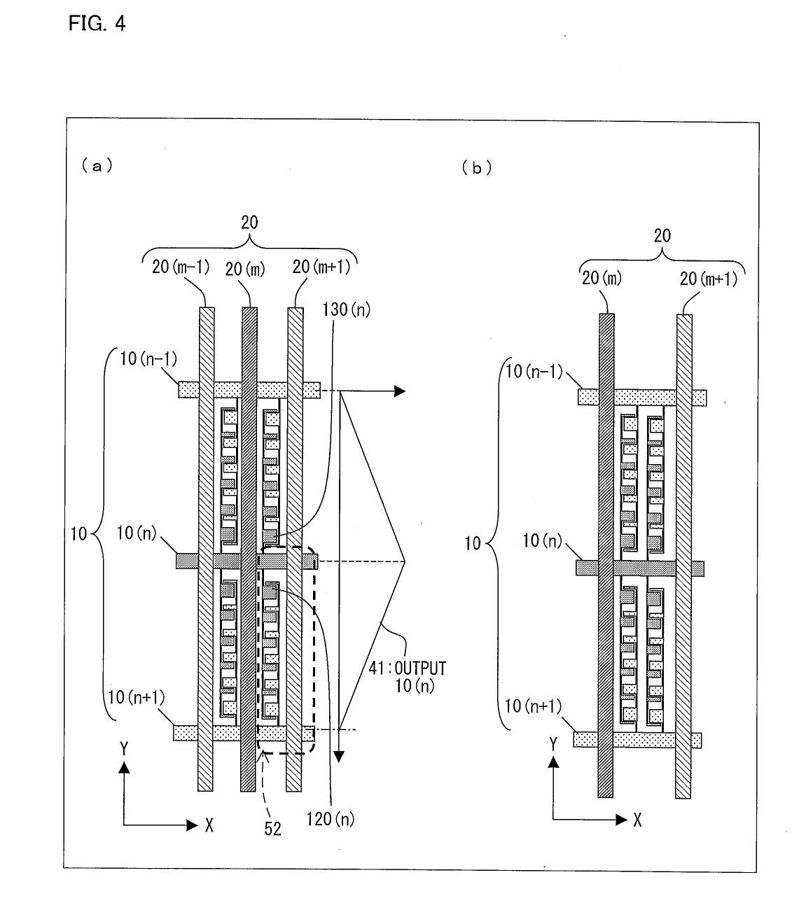

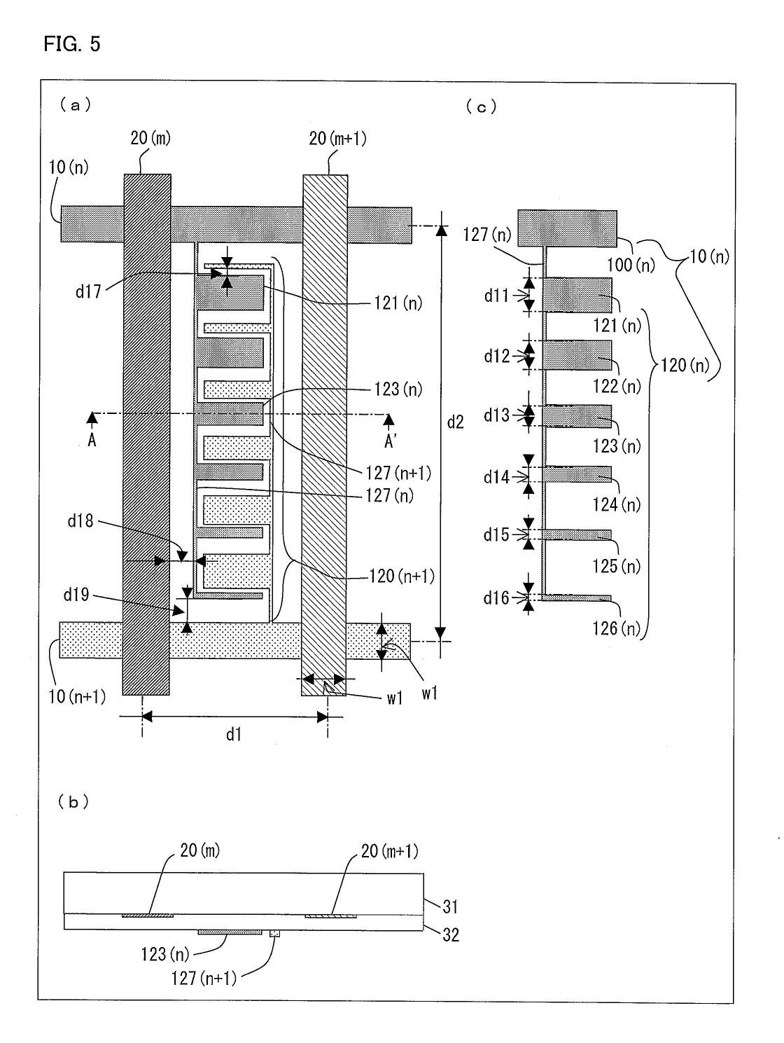

FIGS. 4 and 5 are views each illustrating a second embodiment (Embodiment 2) of the present invention. In FIG. 4, (a) of FIG. 4 schematically illustrates a configuration of a touch panel according to Embodiment 2 of the present invention, and (b) of FIG. 4 illustrates a modified example of Embodiment 2. First, with reference to (a) of FIG. 4 and FIG. 5, the following discusses Embodiment 2.

As illustrated in (a) of FIG. 4, Embodiment 2 of the present invention includes a driving electrode group 10 that is made of a plurality of driving electrodes 10(n−1), 10(n), 10(n+1), etc. provided in parallel to one another and a sensing electrode group 20 that is made of a plurality of sensing electrodes 20(m−1), 20(m), 20(m+1), etc. provided in parallel to one another. Further, the driving electrode group 10 and the sensing electrode group 20 are configured in a matrix form so as to orthogonally intersect with each other. This configuration is identical to that of Embodiment 1.

Further, as illustrated in (a) of FIG. 4, sub-electrodes of the driving electrode 10(n) is made of a pair of sub-electrodes (sub-electrodes 120(n) and 130(n) in (a) of FIG. 4 corresponds to this pair of sub-electrodes) that extend in an orthogonal direction with respect to the main electrode 100(n) of the driving electrode 10(n) and respectively in opposite directions relative to the main electrode 100(n). This configuration is also identical to that of Embodiment 1.

However, Embodiment 2 is different from Embodiment 1 in configuration of the sub-electrodes of the driving electrode 10(n).

FIG. 5 is a view illustrating a detailed configuration of the sub-electrode 120(n) of the driving electrode 10(n) in Embodiment 2. (a) of FIG. 5 is an enlarged view of a portion enclosed by a box 52 in (a) of FIG. 4. (b) of FIG. 5 is a cross-sectional view taken along line A-A′ in (a) of FIG. 5. Further, (c) of FIG. 5 is a view illustrating one driving electrode 10(n) taken out from (a) of FIG. 5.

In Embodiment 2, as illustrated in details in (c) of FIG. 5, the driving electrode 10(n) includes (i) a main electrode 100(n) and (ii) a sub-electrode 120(n) that is connected to the main electrode 100(n) and that includes six rectangular electrodes 121(n), 122(n), 123(n), 124(n), 125(n), and 126(n). Note that the reference sign 127(n) indicates a connecting line for connecting the above six rectangular electrodes to the main electrode 100(n). Further, although the sub-electrode 120(n) includes the six rectangular electrodes in (a) and (c) of FIG. 5, the number of rectangular electrodes is not limited to 6, and may be any number equal to or greater than one. The sub-electrode only needs to be structured to have a decreasing electrode area gradient from a main electrode 100(n) side to a far side with respect to the main electrode 100(n). Note that in a case where there is one sub-electrode, the sub-electrode needs to be configured to have a smaller dimension in a width direction (Y-axis direction) as compared to a dimension of the main electrode 100(n) in the width direction (Y-axis direction).

As is clear from (a) of FIG. 5, in Embodiment 2, the sub-electrode 120(n) of the driving electrode 10(n) includes a plurality of rectangular electrodes 121(n), 122(n), 123(n), 124(n), 125(n), and 126(n) that are aligned in one line toward an adjacent driving electrode 10(n+1). The plurality of rectangular electrodes have areas that gradually decrease toward the adjacent driving electrode 10(n+1). According to this configuration, as in Embodiment 1, it is possible to obtain a different output signal depending on a touched position as shown by a solid line 41 in a graph of (a) of FIG. 4. This makes it possible to obtain a touched position with a high accuracy.

(b) of FIG. 5 is a view illustrating a cross-sectional structure of the touch panel. In (b) of FIG. 5, the reference sign 31 indicates a transparent substrate typically made of glass or the like. On the transparent substrate 31, the sensing electrodes 20(m), 20(m+1), etc. are formed with a transparent conductor made of, for example, ITO or IZO. Further, for example, PET is applied to form an insulator 32, and on this insulator 32, the driving electrodes 10(n), 10(n+1), etc. are formed. Accordingly, the driving electrodes and the sensing electrodes are insulated from each other via the insulator 32. The transparent substrate 31 has a thickness of, for example, approximately 500 μm. Further, the insulator 32 has a thickness of, for example, 2 μm. Note that (b) of FIG. 5 illustrates a portion of the rectangular electrode 123(n) of the sub-electrode in the driving electrode 10(n) and a connecting line 127(n+1) for connecting between a plurality of rectangular electrodes constituting a sub-electrode 120(n+1) of the driving electrode 10(n+1). Note that the connecting lines 127(n), 127(n+1), etc. each may be a transparent electrode or alternatively a metal line made of Al, Ag, Au or the like so that an electric resistance is decreased.

The following discusses a specific design example (a numerical value example) in Embodiment 2. How a size (numerical value) of each portion is to be set changes depending on a required detection accuracy etc. It is not easy to find out a numerical value that is to be set in designing in order to obtain a required accuracy, because various factors are related to such an accuracy. The present invention is not limited to the numerical values provided below as an exemplary design. However, it is confirmed that performance sufficient for practical use can be obtained by the exemplary design provided below.

In (a) and (c) of FIG. 5, a distance d1 between the sensing electrodes 20(m) and 20(m+1) is 1300 μm, and a distance d2 between the driving electrodes 10(n) and 10(n+1) is 5000 μm. Further, the main electrode 100(n) of the driving electrode 10(n) and the sensing electrodes are configured to have an identical chosen width w1 of 500 μm.

Further, chosen sizes of the plurality of rectangular electrodes constituting the sub-electrode 120(n) of the driving electrodes 10(n) are, from the wider rectangular electrode 121(n) to 126(n), d11=300 μm, d12=250 μm, d13=200 μm, d14=150 μm, d15=100 μm, and d16=50 μm. Note that the sub-electrodes of the driving electrode 10(n+1) have a similar configuration. In addition, a size of the rectangular electrodes 121(n) etc. in a length direction (X-axis direction; a horizontal direction in (a) and (c) of FIG. 5) is configured to be 350 μm, while a distance d1 (an interval in the X direction) of the rectangular electrodes 121(n) etc. is configured to be 1300 μm.

Further, a distance d17 between the sub-electrode 120(n) of the driving electrode 10(n) and the sub-electrode 120(n+1) of the driving electrode 10(n+1) is configured to be 50 μm, and a distance d18 between the sub-electrode 120(n) and the sensing electrode 20(m) is configured to be 200 μm. Furthermore, a distance d19 between the driving electrode 10(n+1) adjacent to the driving electrode 10(n) and an edge of the sub-electrode 120(n) is configured to be 300 μm.

(b) of FIG. 4 illustrates a modified example of Embodiment 2. In this modified example, the sub-electrodes of the driving electrodes have a different structure from that of Embodiment 1. In other words, whereas in Embodiment 2 as illustrated in (a) of FIG. 4, the sub-electrode 120(n) of the driving electrode 10(n) “includes the plurality of rectangular electrodes 121(n), 122(n), 123(n), 124(n), 125(n), and 126(n) that are aligned in one line toward an adjacent driving electrode 10(n+1) and that have areas gradually decreasing toward the adjacent driving electrode 10(n+1)”, in the modified example, there are two lines of “the plurality of rectangular electrodes 121(n), 122(n), 123(n), 124(n), 125(n), and 126(n) that are aligned and that have areas gradually decreasing toward the adjacent driving electrode 10(n+1)”.

This configuration forms a decreasing electrode area gradient of each of the sub-electrodes of the driving electrodes from a main electrode side to a far side with respect to the main electrode. Certainly, it is clear that the driving electrode may be configured to have two or more lines of sub-electrodes.

### Embodiment 3

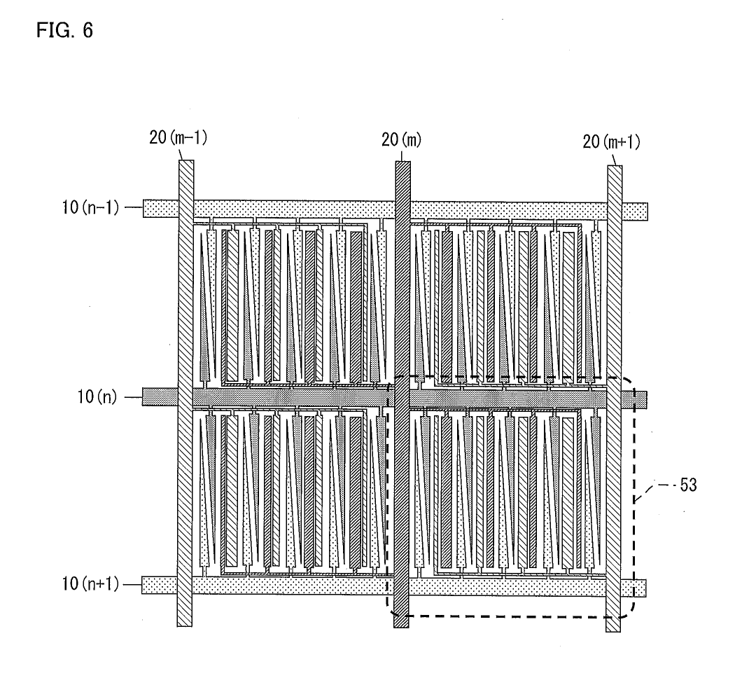

FIGS. 6, 7, and 8 are views each illustrating a third embodiment (Embodiment 3) of the invention of the subject application.

FIG. 6 is a view illustrating a configuration of driving electrodes and sensing electrodes of a touch panel according to Embodiment 3 of the subject application. FIG. 6 is a view illustrating three driving electrodes 10(n−1), 10(n), and 10(n+1) provided in parallel to one another and three sensing electrodes 20(m−1), 20(m), and 20(m+1) provided in parallel to one another. Further, it is illustrated that, in a portion (for example, a portion enclosed by a box 53) enclosed by driving electrodes and sensing electrodes, sub-electrodes of the driving electrodes described later are provided. In the illustration, sub-electrodes of the sensing electrodes are further provided.

In Embodiments 1 and 2 of the present invention, the driving electrodes each include a main electrode and a sub-electrode(s) and the sub-electrode(s) is configured to have a decreasing electrode area gradient from the main electrode side to a far side with respect to the main electrode. Meanwhile, in Embodiment 3, sensing electrodes each are also provided with a sub-electrode(s) (hereinafter, referred to as sensing sub-electrode(s)) and the sensing sub-electrode(s) is configured to have an electrode area gradient.

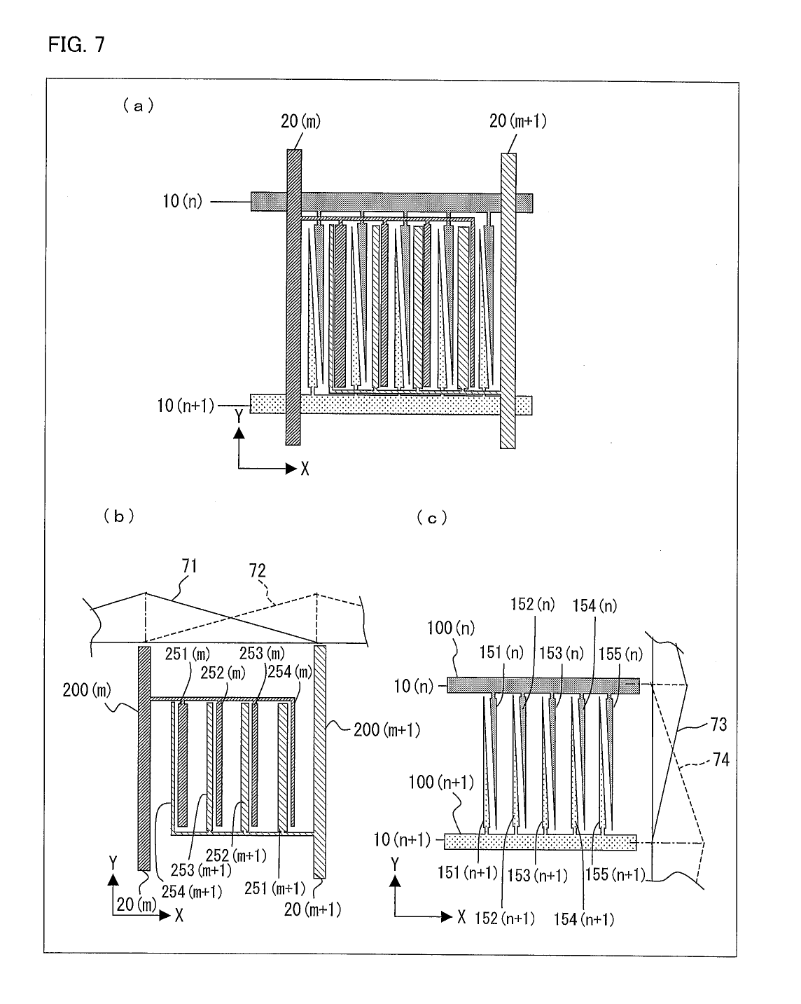

FIG. 7 is a view illustrating the above-described structure and shows a configuration of the portion enclosed by the box 53 in FIG. 6. (a) of FIG. 7 is a view illustrating the portion enclosed by the box 53 of FIG. 6. In (a) of FIG. 7, the driving electrodes 10(n) and 10(n+1) and the sensing electrodes 20(m) and 20(m+1) are illustrated. Further, in the portion enclosed by the driving electrodes 10(n) and 10(n+1) and the sensing electrodes 20(m) and 20(m+1), the sub-electrodes of the driving electrodes and the sensing sub-electrodes of the sensing electrodes are illustrated.

(b) of FIG. 7 is a view illustrating only the sensing electrodes and the sensing sub-electrodes from (a) of FIG. 7. As illustrated in (b) of FIG. 7, the sensing electrode 20(m) includes a sensing main electrode 200(m) and four sensing sub-electrodes 251(m), 252(m), 253(m), and 254(m) electrically connected to the sensing main electrode 200(m). Similarly, as illustrated in (b) of FIG. 7, the sensing electrode 20(m+1) includes a sensing main electrode 200(m+1) and four sensing sub-electrodes 251(m+1), 252(m+1), 253(m+1), and 254(m+1) electrically connected to the sensing main electrode 200(m+1).

Note that the sensing electrodes 20(m) and 20(m+1) are different only in position of a connecting line that electrically connects the sensing sub-electrodes to the sensing main electrode and have basically an identical configuration. The following describes the configuration of the sensing electrodes 20(m) and 20(m+1) by using the sensing electrode 20(m).

The sensing sub-electrodes 251(m), 252(m), 253(m), and 254(m) each are configured to be a rectangular electrode. The sensing sub-electrodes 251(m), 252(m), 253(m), and 254(m) closer to the sensing main electrode 200(m) have larger areas. Accordingly, the sensing sub-electrodes 251(m), 252(m), 253(m), and 254(m) have a decreasing electrode area gradient from a sensing main electrode 200(m) side to a far side with respect to the sensing main electrode.

In other words, the sensing electrode 20(m) includes the sensing main electrode 200(m) extending in the Y-axis direction so as to orthogonally intersect with the driving electrodes 10(n) etc. and sensing sub-electrodes 251(m), 252(m), 253(m), and 254(m) connected to this sensing main electrode 200(m). Further, these sensing sub-electrodes 251(m) through 254(m) have a decreasing area gradient toward the adjacent sensing electrode 20(m+1). Accordingly, due to the same operation principle discussed with reference to (a) and (b) of FIG. 1, it is possible to obtain a detection characteristic as shown by a solid line 71 for the sensing electrode 20(m). Note that a broken line 72 shows a detection characteristic for the sensing electrode 20(m+1).

(c) of FIG. 7 is a view illustrating only the driving electrodes and the sub-electrodes of the driving electrodes of (a) of FIG. 7. The driving electrodes illustrated in (c) of FIG. 7 have a configuration that is substantially identical to that of the modified example of Embodiment 1 as illustrated in FIG. 3. However, whereas in the modified example of Embodiment 1, the number of the pairs of sub-electrodes of the driving electrode 10(n) that are formed between the sensing electrodes 20(m) and 20(m+1) is two (the number of the sub-electrodes is four in total), in Embodiment 3 illustrated in (c) of FIG. 7, the number of the pairs of sub-electrodes of the driving electrode 10(n) that are formed between the sensing electrodes 20(m) and 20(m+1) is 5 (the number of the sub-electrodes is ten in total (note that in (c) of FIG. 7, only “5 sub-electrodes” on one side of the driving electrode 10(n) are illustrated)).

In other words, in a region illustrated in (c) of FIG. 7, the driving electrode 10(n) includes a main electrode 100(n) and five sub-electrodes 151(n), 152(n), 153(n), 154(n), and 155(n) electrically connected to the main electrode 100(n). Further, the driving electrode 10(n+1) includes a main electrode 100(n+1) and five sub-electrodes 151(n+1), 152(n+1), 153(n+1), 154(n+1), and 155(n+1) electrically connected to this main electrode 100(n+1). Note that though a cross-sectional view is not particularly provided in Embodiment 3, a cross-sectional structure in Embodiment 3 may be basically identical to those of Embodiments 1 and 2. Accordingly, a connecting line that electrically connects the sub-electrodes and the main electrode is not limited to a transparent electrode but may be a metal line made of, for example, Al, Ag, Au or the like so that an electric resistance is decreased.

The sub-electrodes of the driving electrode as illustrated in (c) of FIG. 7 each are formed so as to have a triangle shape having a base on a side close to a main electrode of the driving electrode and a vertex on a side close to another main electrode of another adjacent driving electrode. This results in formation of a decreasing electrode area gradient of each of the sub-electrodes from the main electrode to a far side with respect to the main electrode. Accordingly, due to the same operation principle discussed with reference to (a) and (b) of FIG. 1, it is possible to obtain a detection characteristic as shown by a solid line 73 for the driving electrodes 10(n). Note that a broken line 74 shows a detection characteristic for the driving electrode 10(n+1).

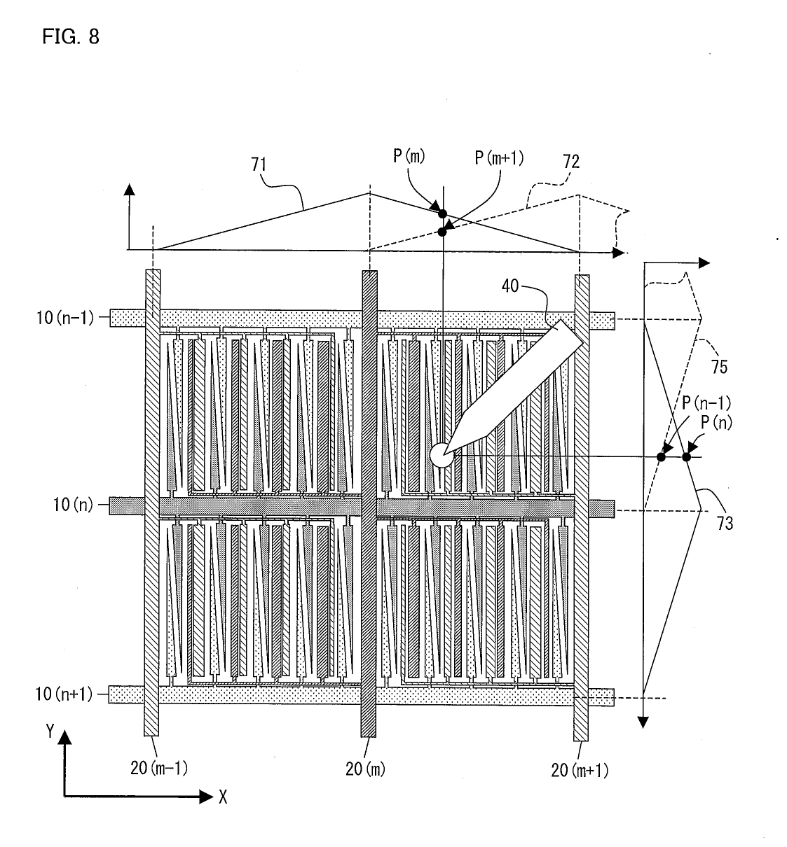

FIG. 8 is a view illustrating a state where a touched position is detected at the time when a pen tip 40 touches a specific position on a touch panel of Embodiment 3. The following discusses, with reference to FIG. 8, a method for determining an X-coordinate position (in a horizontal direction in FIG. 8) and a Y-coordinate position (a vertical direction in FIG. 8) at the time when the pen tip 40 is at the position illustrated in FIG. 8.

In FIG. 8, a solid line 71 shows a detection characteristic of the sensing electrode 20(m) at the time when the driving electrode 10(n) is driven and a broken line 72 shows a detection characteristic of the sensing electrode 20(m+1) at the time when the driving electrode 10(n) is driven, as in (b) of FIG. 7. It is clear that the detection characteristic of the sensing electrode 20(m) has an output characteristic in accordance with an electrode area gradient of the sensing electrode 20(m) and the detection characteristic of the sensing electrode 20(m+1) has an output characteristic in accordance with an electrode area gradient of the sensing electrode 20(m+1).

Further, in FIG. 8, a solid line 73 shows a detection characteristic of the sensing electrode 20(m) at the time when the driving electrode 10(n) is driven, as in (b) of FIG. 7, and a solid line 75 shows a detection characteristic of the sensing electrode 20(m) at the time when the driving electrode 10(n−1) is driven. It is clear that the detection characteristic of the sensing electrode 20(m) has an output characteristic in accordance with an electrode area gradient of the driving electrode 10(n) and the detection characteristic of the sensing electrode 20(m+1) has an output characteristic in accordance with an electrode area gradient of the driving electrode 10(n−1). Note that in (c) of FIG. 7, the broken line 74 shows a detection characteristic of the sensing electrode 20(m) at the time when the driving electrode 10(n+1) is driven.

The X-coordinate position of the touched position where the pen tip 40 touches can be determined by obtaining a ratio of detection outputs of the sensing electrodes 20(m) and 20(m+1) at the time when the driving electrode 10(n) is driven. In other words, as is clear from the solid line 71 and the broken line 72, the detection outputs of the sensing electrodes 20(m) and 20(m+1) at the time when the driving electrode 10(n) is driven vary respectively in accordance with different characteristics, depending on an X-coordinate at a position where the pen tip 40 touches. Accordingly, by taking the ratio of these detection outputs, it is possible to uniquely determine, in the X-axis direction, the touched position where the pen tip 40 touches.

For example, a ratio of a detection output P(m) of the sensing electrode 20(m) and a detection output P(m+1) of the sensing electrode 20(m+1) (detection output P(m)/detection output P(m+1)), at the time when the pen tip 40 is at a position as illustrated in FIG. 8, becomes a different value depending on an X-coordinate position where the pen tip 40 touches. This ratio is uniquely fixed depending on the X-coordinate position. Therefore, by obtaining the value of the ratio, it is possible to determine the X-coordinate position where the pen tip 40 touches.

The Y-coordinate position of the touched position where the pen tip 40 touches can be determined by obtaining a ratio of a detection output of the sensing electrode 20(m) at the time when the driving electrode 10(n−1) is driven and a detection output of the sensing electrode 20(m) at the time when the driving electrode 10(n) is driven. In other words, as is clear from the solid line 73 and the broken line 75, the detection output (solid line 73) of the sensing electrode 20(m) at the time when the driving electrode 10(n) is driven and the detection output (broken line 75) of the sensing electrode 20(m) at the time when the driving electrode 10(n−1) is driven vary in accordance with different characteristics, depending on the Y-coordinate position where the pen tip 40 touches. Accordingly, by taking the ratio of the detection outputs, it is possible to determine, in the Y-axis direction, the touched position where the pen tip 40 touches.

For example, when the pen tip 40 is at the position as illustrated in FIG. 8, an output of the sensing electrode 20(m) at the time when the driving electrode 10(n) is driven is P(n) and an output of the sensing electrode 20(m) at the time when the driving electrode 10(n−1) is driven is P(n−1). In this case, a ratio of these detection outputs (detection output P(n)/detection output P(n−1)) is uniquely fixed depending on the Y-coordinate position where the pen tip 40 touches. Therefore, by obtaining the value of the ratio, it is possible to determine the Y-coordinate position where the pen tip 40 touches.

### CONCLUSION

A touch panel according to one aspect of the invention of the present application, includes: a plurality of driving electrodes provided in parallel to one another; and a plurality of sensing electrodes insulated from the plurality of driving electrodes via an insulator and provided in parallel to one another, the plurality of driving electrodes and the plurality of sensing electrodes being provided in a matrix form so as to orthogonally intersect with each other, the plurality of driving electrodes extending in an X-axis direction of the touch panel, the plurality of sensing electrodes extending in an Y-axis direction of the touch panel, the plurality of driving electrodes each being made of (i) a main electrode extending so as to orthogonally intersect with the plurality of sensing electrodes and (ii) at least a pair of sub-electrodes provided in a region between two adjacent sensing electrodes so as to extend in an orthogonal direction with respect to the main electrode and respectively in opposite directions relative to the main electrode, the pair of sub-electrodes each having a decreasing electrode area gradient from a main electrode side to a far side with respect to the main electrode, and the main electrode and the pair of sub-electrodes of one of the plurality of driving electrodes being electrically connected to each other.

This aspect of the present invention makes it possible to provide a high-performance touch panel that can detect, with a high accuracy, a touched position between driving electrodes without increasing the number of driving electrodes and therefore without lowering of an operation frequency. In other words, because a signal strength varies depending on a driving electrode area, detection accuracy of a touched position is improved by reading the signal strength that varies (that is modulated) depending on the driving electrode area. Further, the number of driving electrodes is not increased. This prevents (i) the operation frequency from disadvantageously lowering or (ii) a signal from being disadvantageously weakened due to decrease in the number of times of integration.

In another touch panel according to one aspect of the invention of the present application, preferably, each of the sub-electrodes of the one of the plurality of driving electrodes is configured to have a triangle shape whose one side is a side of the main electrode and whose vertex is on a side where another main electrode of another adjacent one of the plurality of driving electrodes is provided.

This aspect of the present invention makes it possible to provide a touch panel whose electrode area gradient can be easily designed and whose detection of a position is more accurate. In other words, because a signal strength varies depending on a driving electrode area, detection accuracy of a touched position is improved by reading the signal strength that is modulated depending on the driving electrode area. Further, the number of driving electrodes is not increased. This prevents (i) the operation frequency from disadvantageously lowering or (ii) a signal from being disadvantageously weakened due to decrease in the number of times of integration.

In still another touch panel according to one aspect of the invention of the present application, preferably, the sub-electrodes each is configured to have a right triangle shape.

This aspect of the present invention makes it possible to effectively utilize a space between adjacent sensing electrodes and have an efficient layout of the sub-electrodes relative to the space. Further, a distance between (i) each sub-electrode that is electrically connected to the driving electrode and that has a right triangle shape and (ii) a sensing electrode that is adjacent to the sub-electrode is kept constant. This makes it possible to exclude factors, except the electrode area gradient, that may vary a level of a signal. Consequently, the touch panel can be easily designed.

In yet another touch panel according to one embodiment of the invention of the present application, preferably, each of the sub-electrodes of the one of the plurality of driving electrodes includes a plurality of rectangular electrodes aligned in at least one line toward another main electrode of another adjacent one of the plurality of driving electrodes, the plurality of rectangular electrodes having areas gradually decreasing toward the adjacent driving electrode.

This aspect of the present invention makes it possible to easily form a decreasing electrode area gradient of each of sub-electrodes of a driving electrode from a side where a main electrode of the driving electrode is provided to a far side with respect to the main electrode. Accordingly, it becomes possible to provide a high-performance touch panel that can detect, with a high accuracy, a touched position between driving electrodes without increasing the number of driving electrodes and therefore without lowering of an operation frequency. This aspect of the present invention also makes it possible to have an efficient layout of the sub-electrodes relative to a space in a configuration where driving electrodes and sensing electrodes orthogonally intersect with each other. In addition, a distance between (i) each of the sub-electrodes of the driving electrode and (ii) a sensing electrode that is adjacent to the sub-electrode can be kept constant. This allows exclusion of factors, except the electrode area gradient, that may vary a level of a signal. Consequently, the touch panel can be easily designed.

Further, in a touch panel according to one aspect of the invention of the present application, preferably, the plurality of sensing electrodes each are made of (i) a sensing main electrode extending in the Y-axis direction so as to orthogonally intersect with the plurality of driving electrodes and (ii) a sensing sub-electrode connected to the sensing main electrode, the sensing sub-electrode has a decreasing electrode area gradient toward an adjacent sensing electrode, and the sensing main electrode and the sensing sub-electrode are electrically connected to each other.

This aspect of the present invention makes it possible to accurately detect a touched position where a pen tip or the like touches not only in regard to a position corresponding to adjacent driving electrodes in a case where the touched position is present in a region between the adjacent driving electrodes but also in regard to a position corresponding to adjacent sensing electrodes in a case where the touched position is in a region between the adjacent sensing electrodes. In other words, because a signal strength varies depending on a sensing electrode area, accuracy of detection of the touched position is enhanced by reading the signal strength modulated by the sensing electrode area. Further, because the number of signal electrodes is not increased, an operation frequency is prevented from being disadvantageously lowered or a signal is prevented from being disadvantageously weakened due to a decrease in the number of times of integration.

Furthermore, in a touch panel according to one aspect of the invention of the present application, preferably, the sensing sub-electrode includes at least one rectangular electrode gradually decreasing in area towards the adjacent sensing electrode.

In this aspect of the invention, an area of the sensing sub-electrode becomes smaller, as the sensing main electrode becomes farther. Accordingly, a signal strength is weaker at a position farther from the sensing main electrode. This makes it possible to detect, with a high accuracy, a touched position based on the signal strength. In addition, because the sensing sub-electrode is rectangular, it is easy to design an electrode area gradient of the sensing sub-electrode.

### INDUSTRIAL APPLICABILITY

The present invention is capable of providing a touch panel whose detection accuracy is high and whose operation frequency is not lowered. Accordingly, the present invention has a high industrial applicability.

### REFERENCE SIGNS LIST

10 driving electrode group
20 sensing electrode group
10(n), 10(n−1), and 10(n+1) driving electrodes
20(m), 20(m−1), and 20(m+1) sensing electrodes
100(n) and 100(n+1) main electrodes of driving electrodes
101(n), 102(n), 103(n), and 104(n) sub-electrodes of driving electrode 10(n)
101(n+1), 102(n+1), 103(n+1), and 104(n+1) sub-electrodes of driving electrode 10(n+1)
31 transparent substrate
32 insulator
120(n) sub-electrode of driving electrode 10(n)
121(n), 122(n), 123(n), 124(n), 125(n), and 126(n) rectangular electrodes constituting sub-electrode 120(n)
151(n), 152(n), 153(n), 154(n), and 155(n) sub-electrodes of driving electrode 10(n)
151(n+1), 152(n+1), 153(n+1), 154(n+1), and 155(n+1) sub-electrodes of driving electrode 10(n+1)
200(m) and 200(m+1) sub-electrodes of sensing electrodes
251(m), 252(m), 253(m) and 254(m) sub-electrodes of sensing electrode 20(m)
251(m+1), 252(m+1), 253(m+1) and 254(m+1) sub-electrodes of sensing electrode 20(m+1)

1. A touch panel comprising:
a plurality of driving electrodes provided in parallel to one another; and
a plurality of sensing electrodes insulated from the plurality of driving electrodes via an insulator and provided in parallel to one another,
the plurality of driving electrodes and the plurality of sensing electrodes being provided in a matrix form so as to orthogonally intersect with each other,
the plurality of driving electrodes extending in an X-axis direction of the touch panel,
the plurality of sensing electrodes extending in an Y-axis direction of the touch panel,
the plurality of driving electrodes each being made of (i) a main electrode extending so as to orthogonally intersect with the plurality of sensing electrodes and (ii) at least a pair of sub-electrodes provided in a region between two adjacent sensing electrodes so as to extend in an orthogonal direction with respect to the main electrode and respectively in opposite directions relative to the main electrode,
the pair of sub-electrodes each having a decreasing electrode area gradient from a main electrode side to a far side with respect to the main electrode, and
the main electrode and the pair of sub-electrodes of one of the plurality of driving electrodes being electrically connected to each other.

2. The touch panel as set forth in claim 1, wherein each of the sub-electrodes of the one of the plurality of driving electrodes is configured to have a triangle shape whose one side is a side of the main electrode and whose vertex is on a side where another main electrode of another adjacent one of the plurality of driving electrodes is provided.

3. The touch panel as set forth in claim 2, wherein the sub-electrodes each is configured to have a right triangle shape.

4. The touch panel as set forth in claim 1, wherein the each of the sub-electrodes of the one of the plurality of driving electrodes includes a plurality of rectangular electrodes aligned in at least one line toward another main electrode of another adjacent one of the plurality of driving electrodes, the plurality of rectangular electrodes having areas gradually decreasing toward the adjacent driving electrode.

5. The touch panel as set forth in claim 1, wherein:
the plurality of sensing electrodes each are made of (i) a sensing main electrode extending in the Y-axis direction so as to orthogonally intersect with the plurality of driving electrodes and (ii) a sensing sub-electrode connected to the sensing main electrode;
the sensing sub-electrode has a decreasing electrode area gradient toward an adjacent sensing electrode; and
the sensing main electrode and the sensing sub-electrode are electrically connected to each other.

6. The touch panel as set forth in claim 5, wherein the sensing sub-electrode includes at least one rectangular electrode gradually decreasing in area towards the adjacent sensing electrode.
